(19) United States
(12) Patent Application Publication
(10) Pub. No.: US 2018/0176258 A1
(43) Pub. Date: Jun. 21, 2018

(54) METHOD FOR IMPLEMENTING SECURITY RULES IN A TERMINAL DEVICE

(71) Applicant: Giesecke+Devrient Mobile Security GmbH, München (DE)

(72) Inventor: Vui Huang TEA, Stockholm (SE)

(21) Appl. No.: 15/574,955

(22) PCT Filed: May 17, 2016
(86) PCT No.: PCT/EP2016/000814

§ 371 Date: Nov. 17, 2017

(30) Foreign Application Priority Data
May 18, 2015 (DE) 10 2015 006 435.5

(51) Int. Cl. H04L 29/06; H04W 12/08

(52) U.S. Cl. CPC H04L 63/20; H04B 1/3816; H04W 12/08

(57) ABSTRACT

A method for implementing security rules in a terminal device is provided with a first secure element and one or more second secure elements comprises the step of sending predetermined commands by the first secure element to the terminal device. The first secure element monitors the compliance with predetermined security rules with respect to information concerning the one or more second secure elements and uses the predetermined commands as part of the monitoring.

The invention refers to a method for implementing security rules in a terminal device as well as to a corresponding terminal device.

Nowadays the use of terminal devices having a plurality of security elements is increasing. Particularly, terminal devices are often configurated as so-called BYOD devices (BYOD=Bring Your Own Device) which are used by employees of a company for business as well as privately. One or more secure elements in a BYOD device are provided exclusively for business use whereas one or more other secure elements are only provided for private use. BYOD devices are preferably mobile radio devices and particularly smart phones which comprise a plurality of mobile radio modules (SIM/USIM modules) as secure elements.

Terminal devices provided for both business and private use have the problem that due to the private use business security guidelines are often not met. Particularly, there is the risk that such devices establish insecure communications to networks. This may e.g. result in malware loaded on those devices.

It is an object of the invention to implement security rules in a terminal device having a plurality of secure elements in and easy and flexible way.

This object is solved by the method according to claim 1 and the terminal device according to claim 14, respectively. Preferred embodiments of the invention are defined in the dependent claims.

The method of the invention implements security rules in a terminal device which is provided with a first secure element and one or more second secure elements. Preferably, the terminal device is a mobile radio device. Predetermined commands are sent by the first secure element to the terminal device. The first secure element monitors the compliance with predetermined security rules with respect to information concerning the one or more second secure elements and uses the predetermined commands as part of the monitoring.

The invention has the advantage that, via commands which are sent by the first secure element, security rules with respect to other (second) secure elements can be enforced. Preferably, the predetermined commands are well-known card application toolkit commands which can be transmitted actively by the first secure element to the terminal device. Particularly, the card application toolkit commands are based on the standard ETSI TS 102 223 (“Card Application Toolkit (CAT)”). Nevertheless, the card application toolkit commands may also be based on the standard ETSI TS 101 267 (“SIM Application Toolkit”) or 3GPP 31.111 (“USIM Application Toolkit”). Hence, the term “card application toolkit command” may refer to commands from any of those standards.

The first secure element used in the terminal device is preferably a chip card (also referred as to ICC, ICC=Integrated Circuit Card) and/or an embedded ICC and/or a TEE (TEE=Trusted Execution Environment) and/or a NFC unit (NFC=Near Field Communication) and/or a mobile radio module, particularly a SIM/USIM module. A respective second secure element is preferably a chip card and/or an embedded ICC and/or a mobile radio module (e.g. a SIM/USIM module). Or a virtual SIM, or a remotely connected SIM such as a SIM on a wearable (e.g. smart watch) that is paired with the mobile device.

In a preferred embodiment of the method according to the invention, the first secure element retrieves via a predetermined command of a first type information concerning a respective second secure element and checks this retrieved information against the predetermined security rules. I.e., it is determined whether the retrieved information complies with the security rules. In case of a non-compliance with the security rules by the retrieved information, the first secure element initiates a measure for complying with the predetermined security rules via a predetermined command of a second type. This embodiment uses specific commands for retrieving information and other specific commands for initiating measures for complying with the security rules.

In a preferred variant of the above embodiment, the terminal device, triggered by the predetermined command of the first type, reads from the respective second secure element the information concerning the respective second secure element and transmits this information to the first secure element. If the predetermined commands are card application toolkit commands, the predetermined command of the first type is preferably the command “PERFORM CARD APDU”. Triggered by this command, so-called APDUs (APDU=Application Data Program Unit) are exchanged.

In another preferred variant, the measure for complying with the predetermined security rules comprises switching off the respective second secure element. When using the above card application toolkit commands, the command of the second type for switching off the respective second secure element is preferably the command “POWER OFF CARD”.

In another embodiment, the first secure element informs itself automatically, particularly by registering for an event, about the availability and non-availability of second secure elements via a predetermined command of a specific type. When using the above card application toolkit commands, the second secure element preferably registers for the event “Card Reader Status” and uses as the predetermined command of the specific type the command “GET READER STATUS”.

In another variant of the invention, the information concerning the one or more second secure elements comprises one or more features of a respective second secure element, particularly one or more security features of the respective second secure element and/or at least a part of an identification of a respective second secure element.

In another embodiment in which the one or more second secure elements and optionally also the first secure element are mobile radio modules, the information concerning the one or more second secure elements comprises one or more features of the mobile network operator and/or the mobile network associated with the respective mobile radio module. Particularly, the one or more features of the mobile network operator and/or the mobile network associated with the mobile radio module comprise one or more of the following features:
at least a part of an identification of the mobile network operator;
the feature whether Wifi calls are allowed in the mobile network, where the predetermined security rules are preferably not met if Wifi calls are allowed in the mobile network;
the feature that small cells are supported by the mobile network, where the predetermined security rules are preferably not met if small cells are supported by the mobile network; the feature whether cloned mobile radio modules have appeared for the mobile network operator, where the predetermined security rules are preferably not met if cloned mobile radio modules have appeared for the mobile network operator.

With this variant of the invention, an efficient protection against insecure mobile networks is achieved.

In another embodiment, the predetermined security rules also refer to additional information concerning the terminal device, where the first secure element also uses the predetermined commands as part of a monitoring of the compliance with the predetermined security rules with respect to the additional information.

Besides the above method, the invention refers to a terminal device which is provided with a first secure element and one or more second secure elements, where the terminal device is configured such that during its operation security rules are implemented by a method wherein
predetermined commands are sent by the first secure element to the terminal device;
the first secure element monitors the compliance with predetermined security rules with respect to information concerning the one or more second secure elements and uses the predetermined commands as part of the monitoring.

Preferably, the terminal device is configured to perform one or more preferred variants of the method according to the invention.

In the following, embodiments of the invention will be described in detail with respect to the enclosed figures.

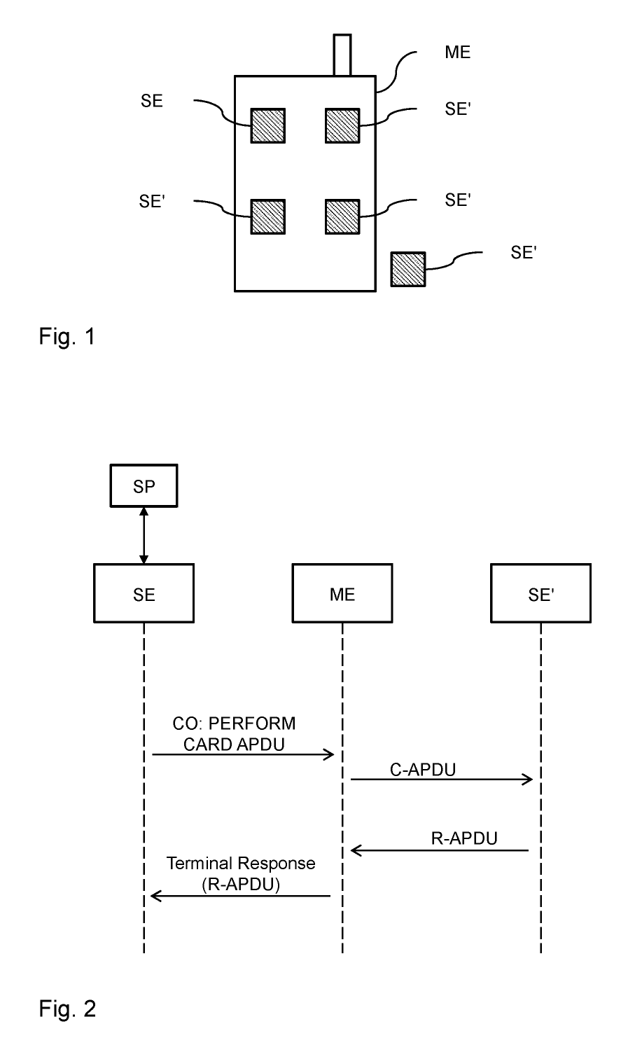

FIG. 1 shows a terminal device having several SIM cards in which an embodiment of the method according to the invention is implemented; and

FIG. 2 shows an example of a retrieval of information for checking security rules according to an embodiment of the method according to the invention.

FIG. 1 is a schematic illustration which shows a terminal device ME in the form of a mobile phone. Four secure elements are inserted in the terminal device ME in corresponding car readers. The secure elements are SIM cards in the embodiment described herein. The SIM card SE is a predefined preferred SIM card which is a variant of a first secure element in the sense of the patent claims. The other three SIM cards SE′ are variants of second secure elements in the sense of the patent claims. The terminal device ME is a so-called BYOD device. Due to the plurality of SIM cards, the device can be used for both private and business purposes. However, it needs to be ensured that all SIM cards comply with corresponding security rules for business use. This is achieved by the method described in the following.

The first secure element SE is used for implementing security rules with respect to the second secure elements SE′. The well-known “Card Application Toolkit (CAT)” according to standard ETSI TS 102 223 is stored on the SIM card SE. This standard comprises a plurality of card application toolkit commands which are programmed on the SIM card and which can be transmitted by the SIM card itself to the terminal device ME. The Card Application Toolkit can be used for both SIM cards and USIM cards. It is also possible to use the “SIM application toolkit” (standard ETSI TS 101 267) or the “USIM application toolkit” (standard 3GPP 31.111). Alt-hough FIG. 1 shows SIM cards, other mobile radio cards or mobile radio modules may be used, such as USIM cards. The method according to the invention may also be performed by those cards. Or a virtual SIM, or a remotely connected SIM such as a SIM on a wearable (e.g. smart watch) that is paired with the mobile device.

According to the invention, predetermined security rules SP (FIG. 2) are implemented by the first secure element SE where the first secure element has access to the security rules, as indi-cated by the double arrow in FIG. 2. To do so, card application toolkit commands (also referred as to CAT commands in the following) according to the standard ETSI TS 102 223 are used. The security rules concern the second secure elements SE′. Hence, it is necessary to detect the current status of the second secure elements when the terminal device ME is started or when a change with respect to a second secure element SE′ occurs.

As mentioned above, the second secure elements SE′ and also the first secure element SE each are inserted in a respective card reader. Hence, in order to detect the status of the second secure elements, the card application toolkit event “Card Reader Status” is used in order to be in-formed about a change in the status of the secure elements. When this event occurs, the CAT command “GET READER STATUS” is sent from the first secure element SE to the terminal device ME in order to receive information about the card readers and the status of the corresponding cards in the readers. Particularly, it is determined whether a card is inserted in the corresponding card reader and switched on. If so, the predetermined security rules with respect to all cards being switched on are checked. The predetermined security rules are preferably stored in the terminal device ME. The security rules may also be stored in the first secure element SE or in an external database outside of the mobile radio device provided that this database can be ac-cessed by the first secure element.

Due to the fact that the predetermined security rules SP refer to the second secure elements SE′, the first secure element SE needs to retrieve information concerning the second secure elements in order to implement the security rules. To do so, the first secure element uses the CAT command “PERFORM CARD APDU”. Based on this CAT commands, the terminal device ME is caused to read information from a respective second secure elements SE′ via so-called APDUs (Application Protocol Data Unit, see standard ISO 7816-4) and to transmit this information to the first secure element SE. This process is illustrated in FIG. 2.

According to FIG. 2, the CAT command CO being the command “PERFORM CARD APDU” is transmitted from the first secure element SE to the terminal device ME. In response to this command, the terminal device ME sends a C-APDU to a corresponding second secure element SE′. This C-APDU comprises a command for retrieving predetermined, publicly available information from the second secure element SE′. Particularly, this information comprises the well-known data elements MCC, MNC, ICCID, LOCI etc. MCC is the country code of the mobile network operator for the secure element SE′ (MCC=Mobile Country Code). MNC is the network code of the mobile network operator (MNC=Mobile Network Code). ICCID is a unique identification of the secure element SE′. LOCI is localization information with respect to the mobile network of the mobile network operator.

The above mentioned information is transmitted in response to the C-APDU via a R-APDU to the terminal device ME. Thereafter, a so-called “Terminal Response” which once again is a R-APDU is transmitted from the terminal device ME to the first secure element SE. In this Terminal Response, the corresponding information from the second secure element SE′ is included.

After having received the Terminal Response, the first secure element SE analyses the information of the corresponding second secure element SE′. In other words, it is checked whether the transmitted information complies with the predetermined security rules SP. E.g., by using the MCC and the MNC, it may be determined at first to which mobile network operator the secure element SE′ belongs. Thereafter, this mobile network operator may be checked against a local or remote database in order to determine the security level of the mobile network of the mobile network operator associated with the secure element SE′. If the security level does not comply with a corresponding requirement in the security rules SP, the non-compliance with the security rules is determined by the secure element SE with the consequence that the secure element SE′ is switched off, as will be described below.

An exemplary definition of security rules will be described based on the following table.

| CRX | MNO | WC | SC | DES | CC | OR |
|---|---|---|---|---|---|---|
| CR0 | A | x | — | — | — | — |
| CR1 | B | — | x | — | — | — |
| CR2 | C | — | — | x | — | — |
| CR3 | D | — | — | — | x | — |
| CR4 | E | — | — | — | — | x |
| CR5 | F | x | x | x | x | x |
| CR6 | G | | | | | |
| CR7 | H | — | — | — | — | — |

The above table refers to a scenario in which eight card readers CR1, CR2, . . . , CR7 are provided in the mobile radio device (see column CRx). A secure element in the form of a SIM card is inserted in each card reader. The SIM card in card reader CR6 is a first secure element in the sense of the patent claims. The other SIM cards in the other card readers are second secure elements in the sense of the patent claims. The mobile network operators MNO of each SIM card are specified in the second column of the table and are named as A, B, . . . , H. The remaining col-umns of the table are features with respect to the SIM cards which are incorporated in the security rules. A feature for a SIM card of a corresponding line is fulfilled if the entry of the feature for the line indicates “x”. If the entry includes the sign “-”, the feature is not fulfilled. For the SIM card in card reader CR6 (i.e. for the first secure element), no features are specified in the above table.

The features of the table are defined as follows:

WC (=Wifi calling): The mobile network of the corresponding SIM card supports calls via Wifi.

SC (=Small Cell): The mobile network of the corresponding SIM card comprises small cells where the term small cell is known for a skilled person.

DES (=Data Ecryption Standard): The security of the corresponding SIM card is lower than a predetermined security level.

CC (=Cloned Cards): Cloned cards have appeared for the mobile network operator associated with the corresponding SIM card.

OR (=Other Reasons): Other features with respect to the corresponding SIM card.

The security rules SP are not met if at least one feature from the above table for the corresponding SIM card is fulfilled. Hence, according to the above table, the security rules are only met for the card in card reader CR7.

In the embodiment described herein, if it is determined that the security rules are not met, the CAT command “POWER OFF CARD” is output by the first secure element. This command instructs the mobile terminal ME to power off and thus deactivate the card which does not comply with the security rules. In case of the above table, the cards in the card readers CR0 to CR5 are powered off, whereas the card in the card reader CR7 is not powered off.

In the embodiment described herein, the security rules also refer to features of the mobile phone ME. These features are retrieved by the first secure element SE via the CAT command “RUN AT COMMAND”. Via the command “RUN AT COMMAND”, the secure element SE transmits a well-known AT command to the terminal device ME. The AT command is executed by the terminal device and results in a “Terminal Response” which is returned to the secure element SE. Besides the retrieval of information from the terminal device, the command “RUN AT COMMAND” in combination with the associated AT command can also be used in order to comply with security rules with respect to the terminal device. Amongst others, AT commands can be used in order to configure the terminal device or the modem of the terminal device for connecting via a USB cable, an infrared port or via Bluetooth or to retrieve information about the current configuration or the current operational status of the terminal device or its modem.

The embodiments of the invention as described in the foregoing have several advantages. Particularly, security rules in a terminal device can be implemented by a secure element in an easy and flexible way, where card application toolkit commands are used in order to enforce the security rules. Hence, it is possible to implement business guidelines for a terminal device having several secure elements where the device is used for both business and private purposes.

1.-15. (canceled)

16. A method for implementing security rules in a terminal device which is provided with a first secure element and one or more second secure elements, comprising the steps of:
sending predetermined commands by the first secure element to the terminal device;
monitoring by the first secure element the compliance with predetermined security rules with respect to information concerning the one or more second secure elements;
using the predetermined commands as part of the monitoring.

17. A method according to claim 16, wherein the predetermined commands are card application toolkit commands, based on the standard ETSI TS 102 223 or the standard ETSI TS 101 267 or the standard 3GPP 31.111.

18. The method according to claim 16, wherein the first secure element is at least one of the following selected from the group consisting: a chip card, an embedded ICC, a TEE, a NFC unit, a mobile radio module, and that the one or more second secure elements is at least one selected from the group consisting: a chip card, an embedded ICC and a mobile radio module.

19. The method according to claim 16, wherein the first secure element retrieves via a predetermined command of a first type information concerning a respective second secure element and thereafter checks the retrieved information against the predetermined security rules;
wherein the first secure element initiates via a predetermined command of a second type a measure for complying with the predetermined security rules in case that the retrieved information does not comply with the security rules.

20. The method according to claim 19, wherein, initiated by the predetermined command of the first type, the terminal device reads from the respective second secure element the information concerning the respective second secure element and transmits this information to the first secure element.

21. The method according to claim 17, wherein the first secure element retrieves via a predetermined command of a first type information concerning a respective second secure element and thereafter checks the retrieved information against the predetermined security rules;
wherein the first secure element initiates via a predetermined command of a second type a measure for complying with the predetermined security rules in case that the retrieved information does not comply with the security rules;
wherein the predetermined command of the first type is the command “PERFORM CARD APDU”.

22. The method according to claim 19, wherein the measure for complying with the predetermined security rules comprises switching off the respective second secure element.

23. The method according to claim 17, wherein the measure for complying with the predetermined security rules comprises switching off the respective second secure element;
wherein the predetermined command of the second type is the command “POWER OFF CARD”.

24. The method according to claim 16, wherein the first secure element informs itself automatically, by registering for an event, about the availability and non-availability of second secure elements via a predetermined command of a specific type.

25. The method according to claim 16, wherein the information concerning the one or more second secure elements comprises one or more features of a respective second secure element, including one or more security features of a respective second secure element or at least a part of an identification of a respective second secure element.

26. The method according to claim 16, wherein the one or more second secure elements are mobile radio modules and the information concerning the one or more second secure elements comprises one or more features of the mobile network operator or the mobile network associated with the respective mobile radio module.

27. The method according to claim 26, wherein the one or more features of the mobile network operator or mobile network associated with the mobile radio module comprises or of the following features:
at least a part of an identification of the mobile network operator;
the feature whether Wifi calls are allowed in the mobile network, where the predetermined security rules are preferably non met if Wifi calls are allowed in the mobile network;
the feature whether smart cells are supported by the mobile network, where the predetermined security rules are preferably not met if small cells are supported by the network;
the feature whether cloned mobile radio modules have appeared for the mobile network provider, where the predetermined security rules are preferably not met if cloned mobile radio modules have appeared for the mobile network operator.

28. The method according to claim 16, wherein the predetermined security rules also refer to additional information concerning the terminal device, where the first secure element also uses the predetermined commands as part of a monitoring of the compliance with the predetermined security rules with respect to the additional information.

29. A terminal device, provided with a first secure element and one or more second secure elements, where the terminal device is configured such that during its operation security rules are implemented by a method wherein
predetermined commands are sent by the first secure element to the terminal device;
the first secure element monitors the compliance with predetermined security rules with respect to information concerning the one or more second secure elements and uses the predetermined commands as part of the monitoring.

30. The terminal device according to claim 29, wherein the predetermined commands are card application toolkit commands, based on the standard ETSI TS 102 223 or the standard ETSI TS 101 267 or the standard 3GPP 31.111.
